(19) United States
(12) Patent Application Publication
(10) Pub. No.: US 2004/0140903 A1
(43) Pub. Date: Jul. 22, 2004

(54) Precipitation measuring device

(76) Inventor: Kirk Buhler, Corona, CA (US)

Correspondence Address: ROBERT D. FISH; RUTAN & TUCKER, LLP, P.O. BOX 1950, 611 ANTON BLVD., 14TH FLOOR, COSTA MESA, CA, 92628-1950, US

(21) Appl. No.: 10/475,549

(22) PCT Filed: Apr. 18, 2001
(86) PCT No.: PCT/US01/12796

(51) Int. Cl. G08B 21/00

(52) U.S. Cl. 340/602

(57) ABSTRACT

A precipitation measuring device comprises a detector (20) disposed to electronically count individual rain drops, and an integrator (30) that integrates the results over a period of time. The detector (20) may comprise a piezoelectric sensor, a strain gauge, or some other type of detector that electronically detects the impact of individual rain drops. The integrator (30) may comprise hardware logic or a microprocessor. The detector (20) and integrator (30) may be disposed in the same or separate housings. The precipitation measuring device may also be used to prevent the execution of an irrigation schedule by an irrigation controller (200) when rain occurs. When used for this purpose the integrator (30) may comprise the microprocessor disposed in the irrigation controller.

### FIELD OF THE INVENTION

The field of the invention is precipitation measuring devices.

### BACKGROUND OF THE INVENTION

In arid areas of the world, water is becoming one of the most precious natural resources. Meeting future water needs in these arid areas may require aggressive conservation measures. This requires irrigation systems to apply water to the landscape based on the water requirements of the plants, and also limits the automatic irrigation of the landscape when adequate moisture is occurring due to natural rainfall. Automatic irrigation controllers control the release of water to the various zones by the automatic activation of irrigation valves. Today, some irrigation systems have rain detectors that automatically override the activation of irrigation valves when rain occurs. This prevents excessive water from being applied to the landscape that is both detrimental to the plants and is also a waste of water.

There are many different types of precipitation (rain) measuring devices. Some of the earliest precipitation measurement devices were rain collectors with visual markings on them to indicate the quantity of rain that occurred during a period of time. Rain detectors are discussed in U.S. Pat. No. 5,101,083, issued March 1992 to Tyler, et al., U.S. Pat. No. 4,613,764, issued September 1986 to Lobato, U.S. Pat. No. 5,312,578, issued June 1994 to Morrison et. al, U.S. Pat. No. 5,355,122 issued October 1994 to Erickson, and U.S. Pat. No. 5,836,339 issued November 1998 to Klever. With many of these rain detectors, a currently executed irrigation application can be terminated with the onset of rain, or shortly thereafter, by interrupting the electrical circuit from the irrigation controller to the irrigation valves.

It is also known for rain detectors to provide a means for modifying an irrigation schedule so that subsequent irrigation applications apply less water than would otherwise be applied. For this purpose, however, it is not sufficient merely to detect rainfall. Instead the system must somehow detect how much rain has fallen, and more preferably other characteristics such as the intensity of the rainfall (i.e. amount of rainfall over a given period of time).

More complex precipitation measurement devices are known that attempt to satisfy these needs. To date, such devices collect the rainfall, and measure the total amount of collected rainfall using weight or other fluid volume measuring concepts. The use of a load cell to measure precipitation is discussed in U.S. Pat. No. 6,038,920, issued March 2000 to Gilbert, et al. A volume measuring device that counts standard drops from a collected pool is discussed in U.S. Pat. No. 5,421,198, issued June 1995 to More, III, et al. All of these devices are unnecessarily complicated.

What is needed is a very simple, cost effective precipitation device that can directly measure the precipitation as it impacts a detector. Additionally, it would be advantageous if such a device could be used to prevent or modify execution of an irrigation schedule by an irrigation controller as a function of the amount of rain detected.

### SUMMARY OF THE INVENTION

The present invention provides devices and methods in which a detector is disposed to electronically detect an impact of individual rain drops as they are falling from the sky. An integrator is used to integrate (sum) the detection of the plurality of rain drops over a period of time.

The detector preferably comprises a piezoelectric sensor, although all other detectors that electronically detect the impact of the plurality of individual rain drops (having non-uniform size) are also contemplated, including a strain gauge.

The integrator is coupled to the detector by any suitable connection, including hardwire and/or wireless connection. The detector and integrator may be disposed in the same housing or in separate housings, one of which may be an irrigation controller or a personal computer. The integrator advantageously comprises hardware logic, such as a microprocessor, which is programmed to estimate a quantity of rain detected by the detector over a twenty-four or other period of time. The estimated quantity of rain may be used to affect an irrigation schedule. The integrator may be connected to a switching circuit that can then be connected to a separate irrigation controller.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a schematic of a part of a prior art precipitation measuring device.

FIG. 2 is a schematic of an alternative embodiment of a part of a prior art precipitation measuring device.

FIG. 3 is a schematic of a part of a precipitation measuring device according to an aspect of the present invention.

FIG. 4 is a schematic of a first alternative embodiment of a part of a precipitation measuring device according to an aspect of the present invention.

FIG. 5 is a schematic of a second alternative embodiment of a part of a precipitation measuring device according to an aspect of the present invention.

FIG. 6 is a schematic of the detector and integrator disposed in the same housing.

FIG. 7 is a schematic of the detector disposed in a separate housing and the integrator disposed in an irrigation controller.

FIG. 8 is a schematic of an irrigation controller.

FIG. 9 is a block diagram of an automatic irrigation system with a precipitation measuring device according to an aspect of the present invention.

### DETAILED DESCRIPTION

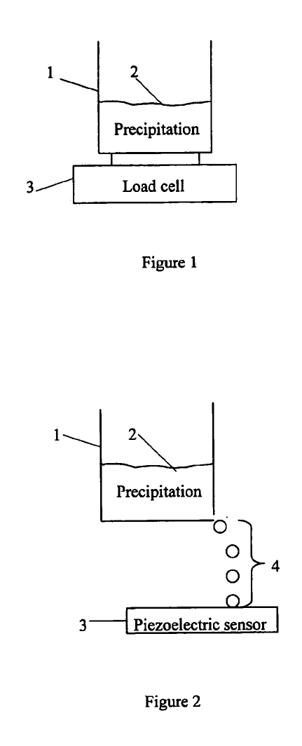

Referring to FIG. 1, which is a drawing of a part of a prior art precipitation measuring device, the precipitation 2 is collected in a water collection device 1. The electronic sensing device 3, which is a load cell in this example, measures the precipitation 2 that is collected in the water collection device 1.

Referring to FIG. 2, which is a drawing of an alternative embodiment of a part of a prior art precipitation measuring device, the precipitation 2 is again collected in a water collection device 1. The electronic sensing device 3, which is a piezoelectric sensor in this example, detects the number of uniform droplets of water 4 that fall from the water collection device 1.

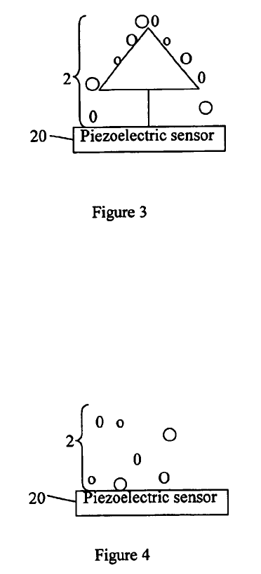

FIG. 3 is a drawing of a part of a precipitation measuring device according to an aspect of the present invention. The precipitation 2 collects or falls on a cone or similar shaped element and then directly impacts the detector 20, which is a piezoelectric sensor in this example. The detector 20 electronically detects an impact of a plurality of individual non-uniform rain drops of the precipitation 2.

FIG. 4 is a drawing of a first alternative embodiment of a part of a precipitation measuring device according to an aspect of the present invention. The precipitation 2 impacts directly on the detector 20, which is a piezoelectric sensor in this example. The detector 20 electronically detects an impact of a plurality of individual non-uniform rain drops of the precipitation 2.

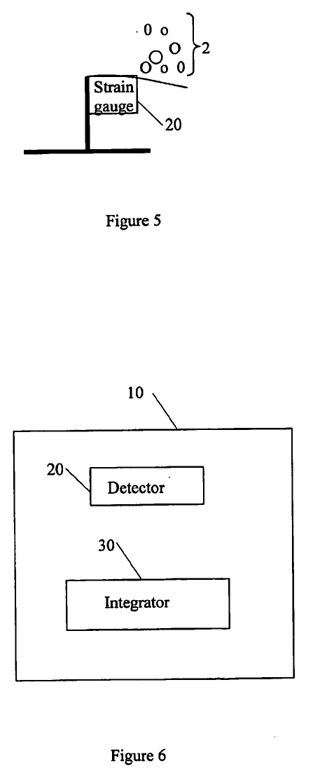

FIG. 5 is a drawing of a second alternative embodiment of a part of a precipitation measuring device according to an aspect of the present invention. The precipitation 2 impacts directly on an element that is a part of detector 20, which is a strain gauge in this example. The detector 20 electronically detects an impact of a plurality of individual non-uniform rain drops of the precipitation 2.

Referring to FIG. 6, the detector 20 may be housed in the same housing 10 with the integrator 30. The detector 20 electronically detects an impact of a plurality of individual rain drops. The integrator 30 integrates the detection of the plurality of rain drops to arrive at a sum total of rain drops that impact the detector 20 during a period of time. Preferably the period of time is twenty-four hours but the period of time may be less than or more than twenty-four hours.

The integrator 30 preferably includes a hardware logic or a microprocessor. Where the integrator 30 comprises a microprocessor, the microprocessor may be programmed to use raw data received from the detector 20, to estimate a quantity of rain during a period of time. The period of time utilized in the integration (summation) can be any suitable period of time less than, equal to, or greater than twenty-four hours. “Raw data” is defined herein to mean pulse or other data outputted by the detector 20 and otherwise unprocessed except for formatting changes such as conversion from analog to digital, inclusion of appropriate signals to conform to parallel or serial transmission standards, and so forth. Raw data is preferably closely indicative of precipitation that impacts on the detector 20, and may, for example, include digital, analog, pulse, or binary data taken directly from the detector 20. The raw data is amplified to conform to the microprocessors input signal strength requirements.

In a preferred embodiment the estimate of a quantity of rain during a period of time is derived in a controlled study by comparing the relationship between the detector 20 output from the detections of the impact of the plurality of individual rain drops during a given period of time and an actual measurement of rain that occurs during the same given period of time.

In another aspect of the preferred embodiment the invention may suspend irrigation when an initial onset of hard rain is detected even though insufficient rain has accumulated for normal irrigation suspension. The irrigation suspension in this case is imposed for political purposes where city property is being watered, and irrigation during a rainstorm is viewed as wasteful. If the rain shower is hard enough that normal irrigation is suspended, but causes insufficient accumulation for continued irrigation suspension, then the invention may allow normal irrigation to continue after the hard rain has stopped or lessened.

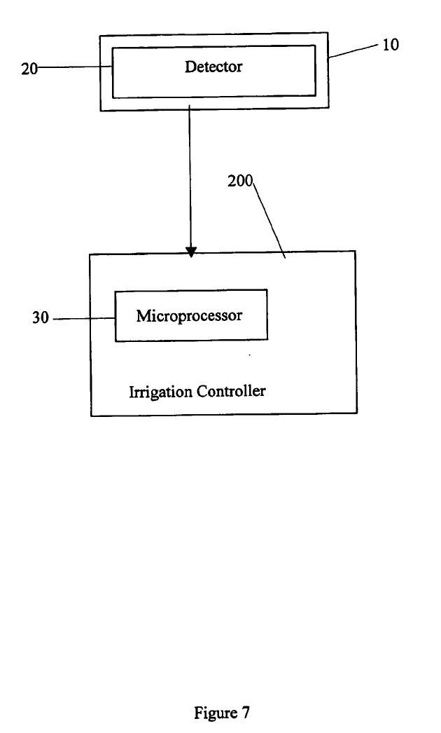

FIG. 7 is an alternative embodiment of the precipitation measuring device with the microprocessor (integrator) 30 disposed in an irrigation controller 200 and the detector 20 in a separate housing 10. It can be appreciated that the microprocessor 30 may be disposed in a personal computer or any other suitable device. In a preferred embodiment the microprocessor 30 is programmed to convert the rain estimate into a rainfall value. The rainfall value may not necessarily be the same as the total rainfall that occurred during a given period of time, because it takes into account one or more other factors such as intensity of rain.

For example, a landscape may only benefit from rains of 0.75 inches or less. Therefore, with rains over 0.75 inches, excess rain over 0.75 inches will tend to run off, and not benefit the landscape. With hard rains, there may also be substantial runoff, resulting in less benefit from the rain than if the rain was a slow steady rain. In a preferred embodiment, the microprocessor 30 is programmed to arrive at a rainfall value based only on rain that will benefit the landscape. Furthermore, it is contemplated that the irrigation controller 200 will use the rainfall value to at least in part affect an irrigation schedule executed by the irrigation controller 200.

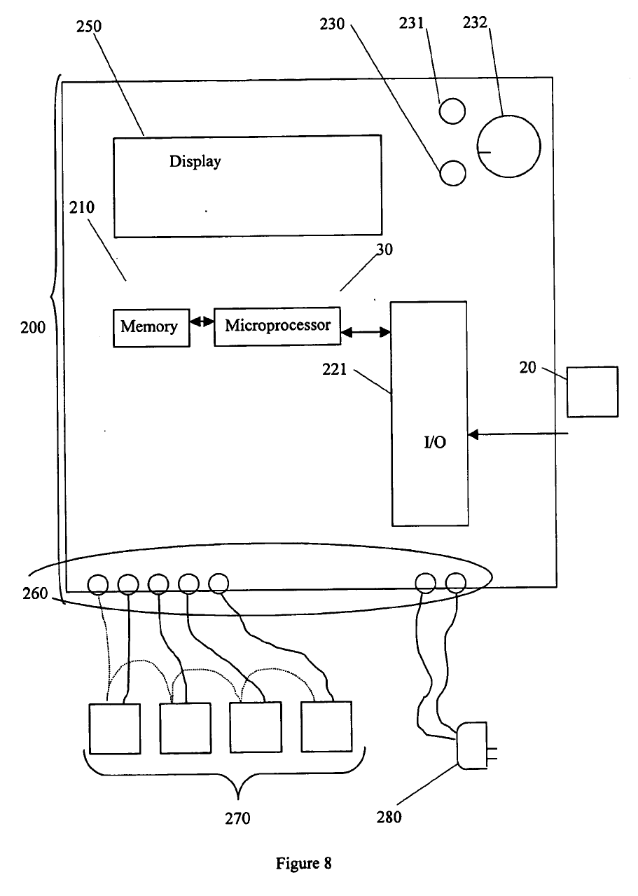

Referring to FIG. 8, an irrigation controller 200 according to the present invention generally includes a microprocessor (integrator) based central processing unit 30, an on-board memory 210, some manual input devices 230 through 232 (buttons and or knobs), an input/output (I/O) circuitry 221 connected in a conventional manner, a display screen 250, electrical connectors 260 which are connected to a plurality of irrigation stations 270 and a power supply 280, and a detector 20. Each of these components by itself is well known in the electronic industry, with the exception of the programming of the microprocessor 30 in accordance with the functionality set forth herein. There are hundreds of suitable chips that can be used for this purpose. Presently, experimental versions have been made using a generic Intel 80C54 chip, and it is contemplated that such a chip would be satisfactory for production models.

In a preferred embodiment of the present invention the irrigation controller 200 has one or more common communication internal bus(es). The bus can use a common or custom protocol to communicate between devices. There are several suitable communication protocols, which can be used for this purpose. Presently, experimental versions have been made using an I²C serial data communication, and it is contemplated that this communication method would be satisfactory for production models. This bus is used for internal data transfer to and from the EEPROM memory, and is used for communication with peripheral devices and measurement equipment including but not limited to water flow sensors, water pressure sensors, and temperature sensors.

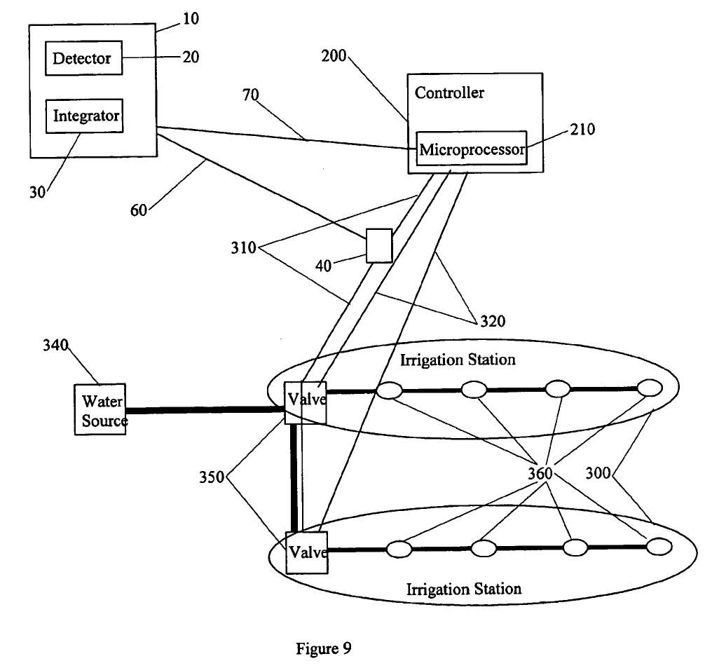

Referring to FIG. 9, an electrical switching circuit 40 would provide an electrical connection between the controller 200 and the irrigation valve(s) 350. From the controller 200 parallel electrical control wires 320 go to each irrigation valve 350. There is generally a common return wire 310 that goes from the irrigation valve(s) 350 back to the controller 200. In a preferred embodiment of the present invention, the electrical switching circuit is electrically connected in series with the common return wire 310 from the valves to the controller. When there is no rain the electrical switching circuit electrically connects the controller 200 to the irrigation valve(s) 350 allowing a scheduled irrigation of the landscape to occur.

When rain water is detected by the precipitation measuring device the electrical switching circuit electrically disconnects the controller 200 from the irrigation valve(s) 350 preventing the scheduled irrigation of the landscape to occur.

Referring again to FIG. 9, in a preferred embodiment of the present invention, the microprocessor 210 and switching circuit 40 are operatively connected 60 and 70 to the integrator 30 that is housed in the housing 10 with the detector 20. As used herein, the term “operatively connected” may mean by a direct connection such as through a hard wire or it could be through a wireless connection, such as an optical, radio, hydraulic or ultrasonic connection. The wireless connection allows the detector and integrator to be located distal from the irrigation controller, and the switching circuit to be located in close enough proximity to the controller to allow for a wired connection.

The irrigation controller 200 operates two irrigation stations 300. It will be understood that these stations 300 are indicative of any two or more irrigation stations, and are not to be interpreted as limiting the number or configuration of irrigation stations. It is contemplated that the irrigation stations may be part of an underground installed irrigation system, such as those used on residential sites, commercial sites, golf courses, public parks, and so forth. Additionally the irrigation stations may be part of center pivot systems, wheel type systems, solid set systems, or any other irrigation system used in the irrigation of plants. Structure and operation of the irrigation controller is preferably as described elsewhere herein except as to the modification of the irrigation schedule according to the rain detected by the detector. Among other things, the irrigation controller 200 operates solenoids (not shown) that open the station valves 350 to allow irrigation water from the water source 340 to be distributed to the various irrigation stations 300 and thereby irrigate the landscape through one or more (four are shown for each irrigation station but it may be any number) irrigation sprinkler heads 360.

In a preferred embodiment, when the irrigation controller 200 is initially installed an irrigation program is programmed into the controller 200, and is stored in the memory (See FIG. 8, 210). Furthermore, the initial irrigation program is preferably modified during the year to execute irrigation of the landscape that meets the water requirements of the landscape plants with a minimum waste of water. The irrigation schedule is preferably at least partly derived from ETo data that will generally result in the irrigation applications closely approximating the water needs of the plants with a minimum waste of water. The ETo value used may advantageously comprise current ETo (i.e., within the last week, three days, or most preferably within the last 24 hours), an estimated ETo value based upon a regression model using one or more of the factors used in calculating ETo (as for example that described in pending U.S. patent application Ser. No. PCT/US00118705), or an historical ETo value (as, for example, that described in pending U.S. patent application Ser. No. PCT/US00/40685).

As soon as the integrator 30 determines that there is an onset of precipitation impacting on the detector 20 the irrigation controller 200 will be prevented from continued execution of a presently executing irrigation schedule. Furthermore, instead of preventing the execution of one or more future complete scheduled irrigation applications, as occurs with known prior art rain detectors, the integrator 30 is programmed to communicate to the microprocessor 210 the quantity of precipitation that occurred and the microprocessor 210 will reduce the quantity of water applied during the next or future scheduled irrigation applications. For example, the integrator 30 estimates that 0.12 inches of precipitation occurred since the last scheduled irrigation. Assume that if no precipitation had occurred since the last scheduled irrigation, the next scheduled irrigation, derived from ETo data, would apply 0.21 inches of water to the landscape. The microprocessor 210 is programmed to subtract the precipitation amount from the regularly scheduled irrigation amount or 0.12 from 0.21, which will result in 0.09 inches of water being applied to the landscape during the next scheduled irrigation. The sensor may not be a sensor as described in claim 1 or 18, and may be mechanical or electrical switch or switches coupled with an irrigation controller in a wired or wireless connection to affect irrigation.

Thus, specific embodiments and applications of methods and apparatus of rain drop measuring have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A precipitation measuring device, comprising:
a detector disposed to electronically detect an impact of a plurality of individual rain drops; and
an integrator that integrates the detection of the plurality of rain drops during a period of time.

2. The precipitation measuring device of claim 1, wherein the detector comprises a piezoelectric sensor.

3. The precipitation measuring device of claim 1, wherein the detector comprises a strain gauge.

4. The precipitation measuring device of claim 1, wherein the individual rain drops are of a non-uniform size.

5. The precipitation measuring device of claim 1, wherein the period of time is twenty-four hours.

6. The precipitation measuring device of claim 1, wherein the integrator is coupled to the detector via a hardwire connection.

7. The precipitation measuring device of claim 1, wherein the detector is coupled to the integrator via a wireless connection.

8. The precipitation measuring device of claim 1, wherein the detector and integrator are disposed in the same housing.

9. The precipitation measuring device of claim 1, wherein the detector and integrator are disposed in separate housings.

10. The precipitation measuring device of claim 1, wherein the integrator comprises a hardware logic.
